(19) United States
(12) Patent Application Publication
(10) Pub. No.: US 2015/0136764 A1
(43) Pub. Date: May 21, 2015

(54) PACKAGE OF THE TWO-MATERIAL BOX TYPE FOR PACKAGING A PRODUCT

(71) Applicants: Philippe DROPSY, Royan (FR); Marie-Claude DROPSY, Royan (FR)

(72) Inventors: Philippe Dropsy, Royan (FR); Marie-Claude Dropsy, Royan (FR)

(21) Appl. No.: 14/413,504

(22) PCT Filed: Jul. 9, 2013
(86) PCT No.: PCT/FR2013/051642

§ 371 Date: Jan. 8, 2015

(30) Foreign Application Priority Data
Jul. 10, 2012 (FR) 1256620

(51) Int. Cl. B65D 21/02; B65D 25/14; B65D 75/32; B29C 51/16

(52) U.S. Cl. CPC B65D 21/0204; B29C 51/162; B65D 25/14; B65D 75/32; B29L 2031/712
USPC 220/4.23; 156/242; 220/4.24

(57) ABSTRACT

A package (1) of the two-material box type for packaging a product, advantageously a foodstuff, includes an outer envelope (2) which is made up of two envelope parts (5, 6) connected by hinge-forming elements (10) for moving them between—a closed position, so as to jointly define a closed storage volume (1′) intended to contain the product, and—an open position so as to allow access to the storage volume (1′), the two envelope parts (5, 6) being internally covered by one and the same sealed one-piece plastics film (3). The two envelope parts (5, 6) are made up of two separate parts; and the sealed plastics film (3) has an interposed strip (10), extending between the two separate envelope parts (5, 6), so as to form the hinge elements.

The present invention relates to the packages of the two-material box type, adapted to package a product, in particular a foodstuff.

The two-material packages are very generally composed of an outer envelope, made of a relatively rigid material, as for example cardboard, which is internally covered with a tight plastic film intended to ensure the tightness.

For the packaging of certain foodstuffs, for example hamburgers or certain cheeses, the outer envelope is advantageously composed of two envelope parts, forming bottom and lid, connected by hinge means, which are movable relative to each other between two positions:

a closed position, held by releasable locking means, to define together a closed packaging volume intended to contain said foodstuff, and

an open position, to allow the access to this packaging volume.

For that purpose, the outer envelope presently consists of a one-piece component, the two envelope parts of which are connected by a one-piece folding line forming the hinge means.

This structure, with a one-piece folding line, is adapted for certain forms of packaging.

But for small packages, or packages of special shapes, this structure is not fully satisfactory; in particular, the setting-up of the outer envelope, with its two envelope parts connected by the folding line, is in practice relatively complex to implement.

The present invention has for object to overcome these drawbacks by proposing a new package structure of the two-material box type which may be easily manufactured in many shapes, and in a great range of sizes, in particular in reduced sizes.

For that purpose, in the two-material package according to the invention, the two envelope parts are made up of two distinct components, and the one-piece tight plastic film includes an insert strip of material, extending between said distinct envelope parts, to form the above-mentioned hinge means.

Making the outer envelope in two parts allow the manufacturing of two-materials packages, in particular of very variable shapes and of reduced sizes, and this using the usual mounting installations; and the inner plastic film is then used to form the hinge for assembling the two envelope parts.

Other advantageous characteristics of the invention, which can be considered independently or in combination, are specified hereinafter:

in the closed position, the outer envelope has two opposite bottom walls that are connected by a lateral wall; the two envelope parts each include a panel forming one of said bottom walls; and one at least of said envelope parts includes a lateral wall extending its bottom panel to form at least a part of the height of said lateral wall; in this case, the two envelope parts have preferably shapes that are identical or at least approximately identical, relative to each other, each comprising a bottom panel extended by a lateral wall;

each envelope part is delimited by a peripheral border extending in a plane; on the other hand, the tight plastic film includes two protruding lateral strips, forming sideways, which are each extended beyond the peripheral border of the envelope part and which each extend in or at least substantially in the plane of the associated envelope part, which two protruding lateral strips are superimposed on each other during the moving of said envelope parts to the closed position, for their tight assembly by degradable fastening means;

the insert strip of the tight plastic film, forming said hinge means, includes a longitudinal ridge defining the axis of rotation between the two envelope parts, which longitudinal ridge extends between the two envelope parts and has a curved cross-section opening on the side of an upper surface of said tight plastic film; in this case, the protruding lateral strips of the two envelope parts extend this insert strip forming the hinge means, and preferably only said protruding lateral strips are assembled with each other by degradable and hermetic fastening means;

the insert strip of the tight plastic film, forming said hinge means, includes a score line defining the axis of articulation between the two envelope parts, which score line extends between the two envelope parts and divides said insert strip into two longitudinal sections intended to be superimposed on each other in the closed position; in this case, the protruding lateral strips of the two envelope parts extend the insert strip forming the hinge means, said protruding lateral strips and the two longitudinal sections of the insert strip being assembled by degradable and hermetic fastening means;

the envelope parts are assembled with the tight plastic film through adhesion means:

the envelope parts each consist in a component made from wood fibres, for example cardboard.

The present invention also relates to a method for obtaining a package of the two-material box type, as defined hereinabove, comprising at least the following successive steps:

providing the two distinct envelope parts, and the one-piece tight plastic film, then

assembling the two envelope parts and the one-piece tight plastic film, which tight plastic film is added so as to make an insert strip between said envelope parts, forming the hinge means.

In this case, the tight plastic film is advantageously assembled on the two envelope parts by a thermoforming operation, in combination with adhesion means.

The invention will be further illustrated, without being limited in anyway, by the following description of a particular embodiment, in relation with the appended drawings in which:

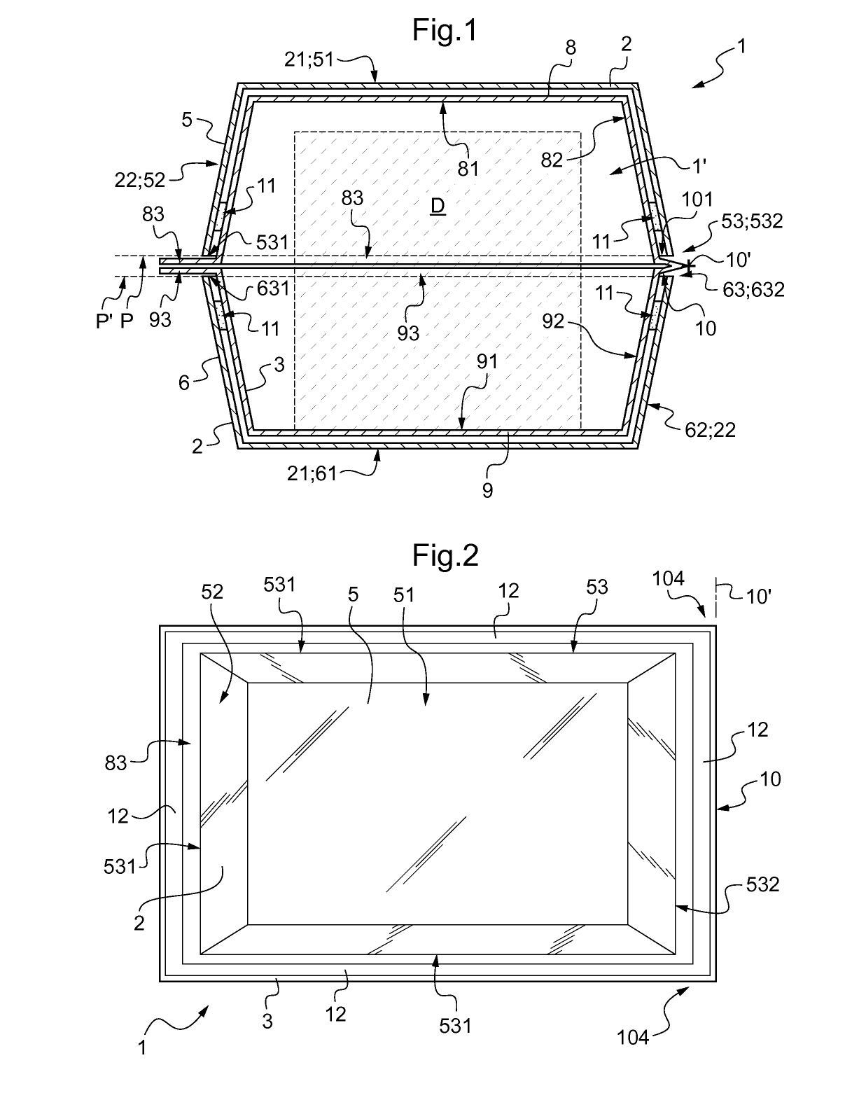

FIG. 1 very schematically shows, according to a longitudinal sectional plane, the package according to the invention in the closed position;

FIG. 2 shows the package of FIG. 1 in the closed position, viewed from above;

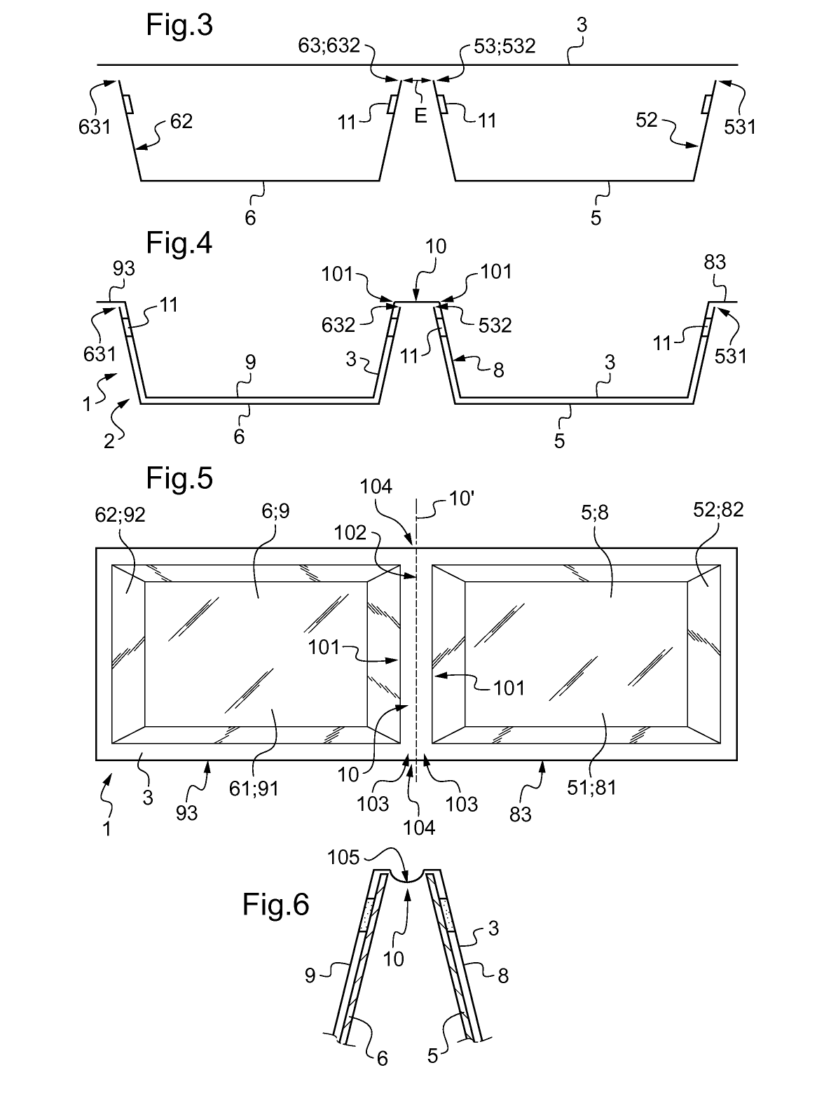

FIGS. 3 and 4 illustrate a method for obtaining the package according to FIGS. 1 and 2, before and after, respectively, an operation of thermoforming the tight plastic film on the two juxtaposed envelope parts;

FIG. 5 is a top view of FIG. 4, showing the package in the open position;

FIG. 6 illustrates a particular embodiment of the insert strip of the tight plastic film forming the hinge means.

The box-type package 1, as shown in the closed position in FIGS. 1 and 2, defines a packaging or storage volume 1′ intended to contain a product D (very schematically shown in FIG. 1).

This package 1 is especially adapted for the packaging of a hamburger, a sandwich or a cheese, but is able to receive any other desired foodstuff.

This two-material-type package 1 comprises an outer envelope 2 that is internally covered with a one-piece tight plastic film 3.

The structure of this package 1 is described hereinafter in relation with FIGS. 1 and 2.

It will be noted that FIG. 1 schematically illustrates the package, in order to show the structure thereof, without taking into account the relative scales between the thicknesses of the envelope parts, of the associated plastic film and of their fastening means.

The outer envelope 2 is composed of two envelope parts that are consisted by distinct components: an upper envelope part 5 consisted by a first component, and a lower envelope part 6 consisted by a second component.

The two envelope parts 5 and 6 are “distinct”, in that they do not constitute a one-piece component. They are not connected directly to each other by a one-piece structural element, for example through a one-piece folding line.

These two envelope parts 5, 6 are hence each elaborated by the setting-up of a suitably cut and ribbed and grooved cardboard blank, for example compact or corrugated cardboard, advantageously of the recyclable cardboard type; they may also be obtained by moulding of a paper paste.

As an alternative, these envelope parts 5, 6 can be made of a cellular plastic material; it may also be made by the association of two materials, for example a mix of cardboard/unrolled wood.

Generally, the nature and thickness of the material constituting the envelope parts 5 and 6 are notably chosen according to the size of the package 1 and according to its purpose.

The two envelope parts 5 and 6 herein have shapes identical to each other.

They each are in the general shape of a tray that is composed of a bottom panel 51, 61 extended by a lateral wall 52, 62.

Each envelope part 5, 6 has herein a generally truncated-pyramid shape; but other polygonal shapes are conceivable (for example, octagonal).

The lateral wall 52, 62 of these two envelope parts 5, 6 each end by a free border 53, 63, arranged remote from their respective bottom panels 51, 61.

The free border 53, 63 of each envelope part 5, 6 extends respectively in, or at least substantially in, a plane P, P′.

The one-piece tight plastic film 3 is also made of a suitable material, preferably polypropylene, possibly complexed with other materials according to the needs.

Generally, the nature and thickness of the material constituting the one-piece plastic film 3 are notably chosen according to the size of the package 1 and according to its purpose.

This tight plastic film 3 consists in a continuous one-piece component covering the two envelope parts 5 and 6.

This tight plastic film 3 may be considered as being divided into different parts visible in FIG. 1, i.e.:

two film parts 8 and 9, each internally covering one of the two envelope parts 5 and 6, and

an insert strip 10, connecting the two film parts 8, 9 and extending between the two envelope parts 5, 6, to form hinge means, for their manual pivotal moving relative to each other.

Each film part 8 or 9, internally conforming one of the envelope parts 5 or 6, is also composed of a bottom panel 81, 91 (forming the inner layer of the bottom panel 51, 61 of the envelope parts 5, 6) connected to a lateral wall 82, 92 (forming the inner layer of the lateral wall 52, 62 of the associated envelope part 5, 6).

These film parts 8 and 9 are assembled and held together with their respective envelope parts 5 and 6, by one or several adhesion areas 11, for example gluing or thermowelding areas.

The adhesion areas 11 are preferably distributed so as to facilitate the later separation of the envelope parts 5, 6 with respect to the plastic film 3, so as to allow their later recycling.

These adhesion areas 11 are arranged, for example, at the adjacent lateral walls 52/82 and 62/92.

These adhesion areas 11 advantageously consist in continuous or discontinuous lines or strips, located on the side of the upper border 53, 63 of the opposite lateral walls 52/82 and 62/92.

Optionally (or possibly as an alternative), the envelope parts 5, 6 and the associated parts 8, 9 of the plastic film 3 can be fastened to each other by one or several adhesion areas located at the opposite bottom panels 51/81 and 61/91 (preferably on the side of the central part of these bottom panels).

Each film part 8, 9 also includes a protruding lateral strip 83, 93, forming a sideway, herein involved in the closing of the package 1.

Each protruding lateral strip 83, 93 covers and extends beyond a first portion 531, 631 of the peripheral border 53, 63 of the associated envelope part 5, 6 (this first portion 531, 631 is composed of several upper edges, herein three upper edges).

Each protruding lateral strip 83, 93 extends in, or at least substantially in, the plane P, P′ of the associated envelope part 5, 6.

The insert strip 10, forming the hinge means, is adapted to undergo a phenomenon of folding in two, by a phenomenon of bending over itself, to define an axis of rotation 10′ between the two envelope parts 5, 6 that are associated thereto.

This axis of rotation 10′ consists in a kind of folding line that is formed between the two envelope parts 5, 6.

In this respect, the insert strip 10 has a generally rectangular shape whose longitudinal borders 101 are each connected to one of the film parts 8, 9 and each cover a second portion 532, 632 of the peripheral border 53, 63 of one of the envelope parts 5, 6.

These second portions 532, 632 of the envelope parts 5, 6 herein consist in two edges that are juxtaposed, extending parallel and close to each other in the open position.

As schematically illustrated in FIG. 5, this insert strip 10 may include a score line 102 defining the axis of rotation 10′ between the two envelope parts 5, 6.

This score line 102 extends between the two envelope parts 5, 6 and divides the insert strip 10 into two longitudinal sections 103 each connected to one of the film parts 8, 9.

The axis of rotation/pivoting 10′ hence advantageously extends along an axis of symmetry of this insert strip 10, parallel to the two longitudinal borders 101 and at the same distance relative to these latter.

At its ends 104, this insert strip 10 is also connected to the protruding lateral strips 83, 93 that extend the upper border of the envelope parts 5, 6 (as can be seen in particular in FIG. 5).

This embodiment has the interest to form a continuity in the protruding strips, allowing to obtain a perfect tightness upon the releasable locking of the upper part with the lower part.

The envelope parts 5, 6 as well as the film parts 8, 9 that are associated thereto, are hence manually pivotally movable about the axis of rotation 10′ between:

a closed position (FIGS. 1 and 2), hence held by releasable locking means (described in more detail hereinafter) to define together the closed storage volume 1′, and

an open position (FIGS. 4 and 5), to allow the access to this storage volume 1′.

In the open position, the two envelope parts 5, 6 are connected to each other only by the insert strip 10 of the tight plastic film 3.

A foodstuff may then be deposited on the film part 8, 9 of one of the envelope parts 5, 6.

To obtain the closed position, the two envelope parts 5, 6 are then moved relative to each other by the folding of the insert strip 10 along the axis of rotation 10′.

These two envelope parts 5, 6 then come in position opposite to each other, with their bottom panels 51, 61 opposite to each other and remote from each other.

The peripheral borders 53, 63 of their lateral walls 52, 62 come in juxtaposition; they are herein separated only by the protruding lateral strips 83, 93 superimposed on each other and also by the insert strip 10 folded outwardly.

The planes P, P′ of the two envelope parts 5, 6 hence extend parallel relative to each other, and advantageously merged, or at least approximately merged, with each other.

The envelope parts 5, 6 hence form together the outer envelope 2 of the package, which is composed of:

two bottom walls 21, each consisted by the bottom panel 51, 61 of one of the envelope parts 5, 6, and

a lateral wall 22, consisted by the juxtaposed lateral walls 52, 62 of the two envelope parts 5, 6 (the lateral wall 52, 62 of an envelope part 5, 6 forms a part of the height of the lateral wall 22 of the outer envelope 2).

To hold the closed position, the superimposed protruding lateral strips 83, 93 of the two envelope parts 5, 6 are assembled with each other by degradable and hermetic fastening means 12, for example by a continuous connection strip that is obtained by thermowelding or through a heat-activatable glue.

This connection strip 12 advantageously includes a weakness area, advantageously formed in an angle, at the opposite of the insert strip 10 forming the hinge means, to facilitate its moving to the open position.

The connection strip 12 is herein also applied at the insert strip 10 to ensure the full tightness of the storage volume 1′. The two longitudinal sections 103 of the insert strip 10 are hence superimposed and assembled with each other, by the degradable and hermetic connection strip 12.

The connection strip 12 herein consists in a closed continuous strip, or loop, herein of generally rectangular shape, extending over the whole perimeter of the outer envelope 2.

To accede to the product, it is then just required to exert a traction on the two protruding lateral strips 83, 93, advantageously at the weakness area, so as to degrade the connection strip 12 and to allow a return of the package 1 to the open position by pivoting of the envelope parts 5, 6 at the insert strip 10.

As an alternative, these fastening means 12 may be consisted by complementary structures equipping the two envelope parts 5, 6 and intended to interlock together when the parts are moved to the closed position.

A method for obtaining such a package 1 is described hereinafter in relation with FIGS. 3 and 4.

This method begins by the provision of the different constitutive components of this package 1, i.e.:

the two distinct envelope parts 5, 6, each consisted for example by a previously set-up cardboard blank, and

the one-piece tight plastic film 3.

The two envelope parts 5, 6 are juxtaposed relative to each other, forming between them a horizontal space E between one of the sides of their respective peripheral borders 53, 63. This horizontal space E is intended to define the width of the insert strip 10 of the tight plastic film 3, to form the hinge of the package.

These envelope parts 5, 6 are for that purpose added in a thermoforming mould including two places each intended to receive one of said envelope parts 5, 6.

Before the placing of the tight plastic film 3, the envelope parts 5, 6 are advantageously pasted, herein at the inside of their lateral walls 52, 62 along the above-mentioned adhesion areas 11.

The adhesion between the envelope parts 5, 6 and the plastic film 3 may be made by the characteristics of this film, wherein the latter can include a heat-reactivatable adhesive face.

The one-piece tight plastic film 3 is then added on these two envelope parts 5, 6 through a thermoforming operation, to directly form the two film parts 8, 9 conforming the associated envelope parts 5, 6.

This placing of the plastic film 3 also allows to obtain, as can be seen in FIGS. 4 and 5, the following strips:

the insert strip 10 between the two envelope parts 5, 6, extending along the second portions 532, 632 of theirs peripheral borders 53, 63, and

the protruding lateral strips 83, 93 at each of its envelope parts 5, 6, along the first portions 531, 631.

This method hence allows to obtain the package 1 according to the invention, originally in the open position.

Another particular embodiment of the insert strip 10 of the tight plastic film 3 is illustrated in FIG. 6.

In this case, this insert strip 10 includes a longitudinal ridge 105 extending between the two envelope parts 5, 6. The ends 104 of this insert strip 10 are also connected to protruding lateral strips 53, 63 forming a sideway.

This ridge 105 has a curved cross-section, for example according to an arc of a circle, opening on the side of the upper surface of the tight plastic film 3 (extending at the opposite of the associated envelope parts 5, 6).

This embodiment allows to obtain a relatively narrow insert strip (for example, of the order of 1 to 5 mm wide) adapted to generate the axis of rotation 10′.

This embodiment has the interest to use a minimum of film for the searched effect.

In this case, for the tight closing of the package 1, the connection strip 12 is formed at the superimposed protruding lateral strips 83, 93 and ends at the lateral ends 104 of the insert strip 10.

The connection strip 12 hence consists in an open continuous strip, herein generally U-shaped, extending over a part of the perimeter of the outer envelope 2.

According to an alternative embodiment, not shown, one of the envelope parts of the package is different of the embodiment described hereinabove in relation with FIGS. 1 to 6 in that it is composed only of a bottom panel (denoted by the reference 51 or 61), with no lateral wall (denoted by the reference 52 or 62), to form a kind of mobile planar lid pivoting with respect to the other envelope part shaped as a tray.

Here again, these two envelope parts may be held together in the closed position by the fastening of their superimposed protruding lateral strips.

1-10. (canceled)

11. A package of the two-material box type for the packaging of a product, which package (1) includes an outer envelope (2) that is composed of two envelope parts (5, 6) connected by hinge means (10) for their moving between two positions:—a closed position, held by releasable locking means (12), to define together a closed storage volume (1′) intended to contain said product, and—an open position, to allow the access to said storage volume (1′), which two envelope parts (5, 6) are internally covered with a same one-piece tight plastic film (3), wherein the two envelope parts (5, 6) are consisted by two distinct components, and the tight plastic film (3) includes an insert strip (10), extending between said two distinct envelope parts (5, 6), to form said hinge means.

12. The package of the two-material box type according to claim 11, wherein, in the closed position, the outer envelope (2) has two opposite bottom walls (21) that are connected by a lateral wall (22), the two envelope parts (5, 6) each include a panel (51, 61) forming one of said bottom walls (21), and at least one of said envelope parts (5, 6) include a lateral wall (52, 62) extending its bottom panel (51, 61) to form at least a part of the height of said lateral wall (22).

13. The package of the two-material box type according to claim 12, wherein the two envelope parts (5, 6) have shapes that are identical or at least approximately identical, relative to each other, each comprising a bottom panel (51, 61) extended by a lateral wall (52, 62).

14. The package of the two-material box type according to claim 11, wherein each envelope part (5, 6) is delimited by a peripheral border (53, 63) extending in a plane (P, P′), the tight plastic film (3) includes two protruding lateral strips (83, 93), forming sideways, which are each extended beyond the peripheral border (53, 63) of the associated envelope part (5, 6) and which each extend in or at least substantially in the plane (P, P′) of the peripheral border of the associated envelope part, which two protruding lateral strips (83, 93) are superimposed on each other during the moving of said envelope parts (5, 6) to the closed position, for their tight assembly by degradable fastening means (12) forming the removable locking means.

15. The package of the two-material box type according to claim 11, wherein the insert strip (10) of the tight plastic film (3), forming said hinge means, includes a longitudinal ridge (105) defining the axis of rotation (10′) between the two envelope parts (5, 6), which longitudinal ridge (105) extends between the two envelope parts (5, 6) and has a curved cross-section opening of the side of an upper surface of said tight plastic film (3).

16. The package of the two-material box type according to claim 11, wherein the insert strip (10) of the tight plastic film (3), forming said hinge means, includes a score line (102) defining the axis of articulation (10′) between the two envelope parts (5, 6), which score line (102) extends between the two envelope parts (5, 6) and divides said insert strip into two longitudinal sections (103) intended to be superimposed on each other in the closed position.

17. The package of the two-material box type according to claim 11, wherein the envelope parts (5, 6) are assembled with the tight plastic film (3) through adhesion means (11).

18. The package of the two-material box type according to claim 11, wherein the envelope parts (5, 6) each consist in a component made from wood fibres, for example cardboard.

19. A method for obtaining a package of the two-material box type according to claim 11, comprising at least the following successive steps:
providing the two distinct envelope parts (5, 6), and the one-piece tight plastic film (3), and
assembling the two envelope parts (5, 6) and the one-piece tight plastic film (3), which tight plastic film (3) is added so as to make an insert strip (10) between said envelope parts (5, 6), forming the hinge means.

20. The method according to claim 19, wherein the tight plastic film (3) is assembled on the two envelope parts (5, 6) by a thermoforming operation, in combination with adhesion means (11).
